(19) United States
(12) Patent Application Publication
(10) Pub. No.: US 2017/0327363 A1
(43) Pub. Date: Nov. 16, 2017

(54) BREACHING TOOLS

(71) Applicant: Greg Poulos LLC, Crystal Lake, IL (US)

(72) Inventor: Greg Poulos, Crystal Lake, IL (US)

(21) Appl. No.: 15/595,875

(22) Filed: May 15, 2017

Related U.S. Application Data
(63) Continuation-in-part of application No. 29/564,556, filed on May 13, 2016, now Pat. No. D795668.
(60) Provisional application No. 62/427,997, filed on Nov. 30, 2016.

(51) Int. Cl. B66F 15/00

(52) U.S. Cl. CPC B66F 15/00

(57) ABSTRACT

An example breaching tool disclosed herein includes a rod. A block is coupled to the rod. The block includes a first side and a second side opposite the first side. The first side defines a striking surface, and a bill extends from the second side of the block. A first tab is coupled to the rod and the second side of the block. The first tab defines a portion of a first aperture having a first orientation. The breaching tool further includes a fork coupled to the rod. A second tab is coupled to the rod and the fork. The second tab defines a portion of a second aperture having a second orientation. The second orientation is substantially orthogonal to the first orientation.

### RELATED APPLICATIONS

This application is a continuation-in-part of and claims priority to U.S. application Ser. No. 29/564,556, entitled “Breaching Tool” and filed on May 13, 2016. This application also claims priority to U.S. Provisional Application No. 62/427,997, entitled “Breaching Tools” and filed on Nov. 30, 2016. Both U.S. application Ser. No. 29/564,556 and U.S. Provisional Application No. 62/427,997 are incorporated by reference herein in their entirety.

### BRIEF DESCRIPTION OF THE DRAWINGS

FIG. 1 is an isometric view of a breaching tool in accordance with the teachings of this disclosure.

FIG. 2 is a first side view of the breaching tool of FIG. 1.

FIG. 3 is a top view of the breaching tool of FIGS. 1-2.

FIG. 4 is a front view of the breaching tool of FIGS. 1-3.

FIG. 5 is a second side view of the breaching tool of FIGS. 1-4.

FIG. 6 is a rear view of the breaching tool of FIGS. 1-5.

FIG. 7 is a bottom view of the breaching tool of FIGS. 1-6.

FIG. 8 is an isometric view of another embodiment of a breaching tool in accordance with the teachings of this disclosure.

FIG. 9 is a rear view of the breaching tool of FIG. 8.

FIG. 10 is a top view of the breaching tool of FIGS. 8-9.

FIG. 11 is an isometric view of another example breaching tool in accordance with the teachings of this disclosure.

FIG. 12 is a first side view of the breaching tool of FIG. 11.

FIG. 13 is a top view of the breaching tool of FIGS. 11-12.

FIG. 14 is a front view of the breaching tool of FIGS. 11-13.

FIG. 15 is a second side view of the breaching tool of FIGS. 11-14.

FIG. 16 is another isometric view of the breaching tool of FIGS. 11-15.

FIG. 17 is a rear view of the breaching tool of FIGS. 11-16.

FIG. 18 is a bottom view of the breaching tool of FIGS. 11-17.

FIG. 19 illustrates an example strap coupled to the breaching tool of FIGS. 11-18.

Wherever possible, the same reference numbers will be used throughout the drawings and accompanying written description to refer to the same or like components or features. As used in this patent, stating that any component or feature is in any way positioned on (e.g., positioned on, located on, disposed on, or formed on, etc.) another component or feature, means that the referenced component or feature is either in contact with the other component or feature, or that the referenced component or feature is on the other component or feature with one or more intermediate component(s) or feature(s) located therebetween. Stating that any component or feature is in contact with another component or feature means that there is no intermediate component or feature between the two components or features.

### DETAILED DESCRIPTION

Example breaching tools disclosed herein enable a user, such as a firefighter, a police officer, military personnel, or any other person, to force open or breach closed and/or locked doors. The breaching tools may open inward-opening doors and/or outward-opening doors. The example breaching tools disclosed herein may include straps coupled to tabs to enable the breaching tools to be supported, for example, over a shoulder of the user. The tabs may be positioned on the breaching tools such that the tabs do not interfere with an operation of the breaching tools (e.g., prying, ramming, etc.) and/or carrying of the breaching tools via the strap. The breaching tools disclosed herein may have a weight distribution that is substantially balanced to facilitate operation and/or carrying of the breaching tools.

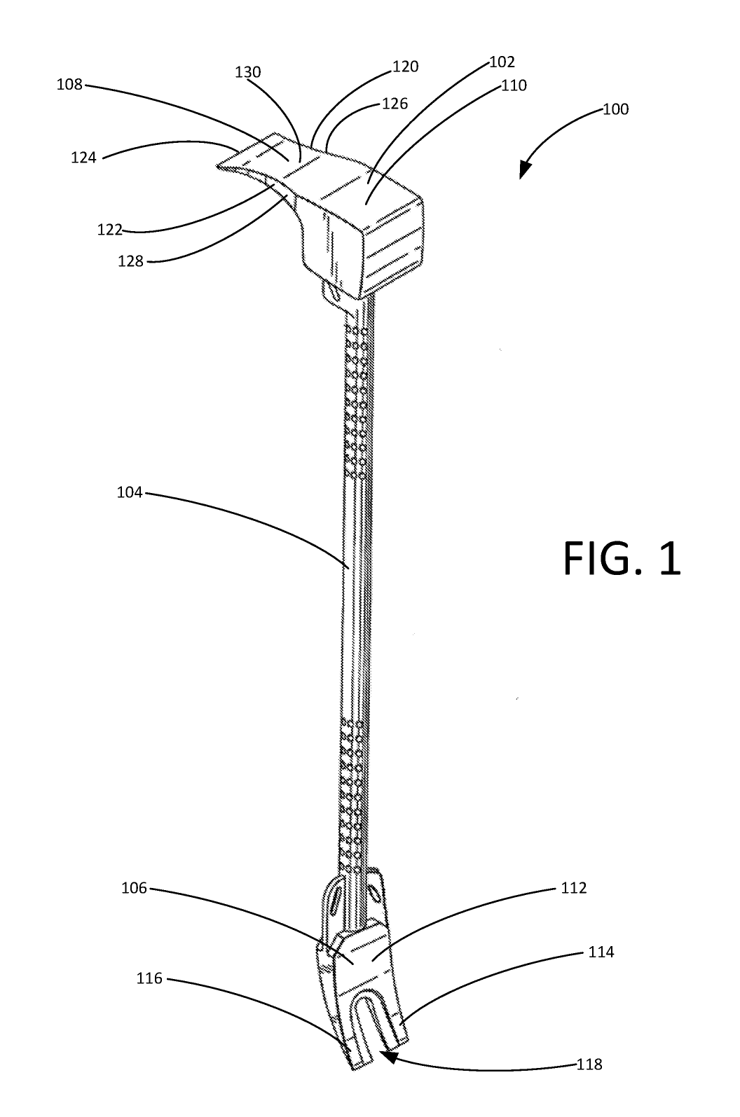

FIG. 1 is a perspective view of an example breaching tool 100 in accordance with the teachings of this disclosure. The breaching tool 100 may be used to, for example, breach doors by prying, ramming, striking, and/or one or more additional and/or alternative operations. The breaching tool 100 of FIG. 1 includes a ram 102, a bar 104, and a fork 106. The ram 102 includes a bill 108 and a head 110. The fork 106 includes a body 112, a first prong 114, and a second prong 116. In the illustrated embodiment, the first prong 114 and the second prong 116 extend from the body 112. The first prong 114 and the second prong 116 are spaced apart and, thus, a gap 118 is disposed between the first prong 114 and the second prong 116. In the illustrated embodiment, the breaching tool 100 has a weight of about 40 pounds. In some embodiments, the breaching tool 100 has other weights. For example, the breaching tool 100 may have a weight of between about 15 pounds and about 55 pounds.

The example bill 108 of FIG. 1 extends from the head 110. The bill 108 includes a first bill side 120, a second bill side 122 opposite the first bill side 120, and an end 124 extending from the first bill side 120 to the second bill side 122. The end 124 of FIG. 1 is substantially straight. In other embodiments, the end 124 may be curved. A first portion 126 of the first bill side 120 is concave. A second portion 128 of the second bill side 122 is concave. In the illustrated embodiment, the first portion 126 is opposite the second portion 128. Thus, the bill 108 includes a minimum width or waist 130 between the end 124 and the head 110 defined by a minimum distance from the first concave portion 126 of the first bill side 120 to the second concave portion 128 of the second bill side 122. In some embodiments, the waist 130 facilitates gripping the breaching tool 100 via the bill 108. In other embodiments, the bill 108 has other shapes and/or configurations. For example, the first bill side 120, the second bill side 122, and/or the end 124 may be straight, convex, and/or one or more additional and/or alternative shapes and/or configurations.

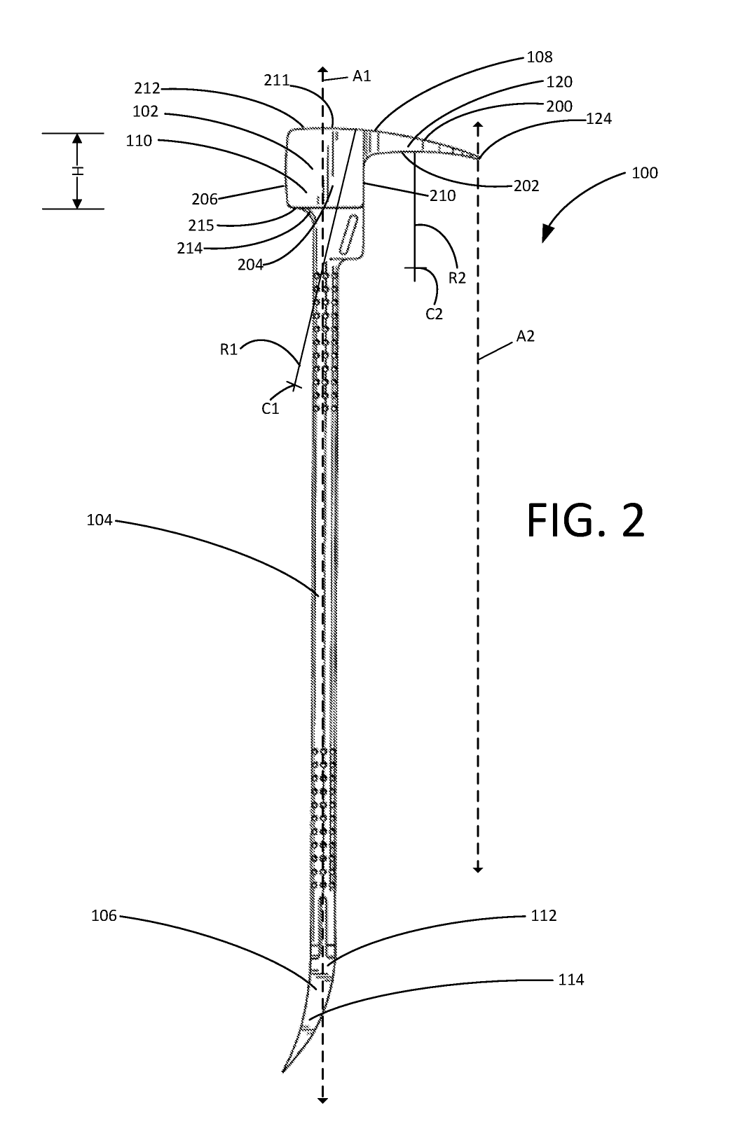

FIG. 2 is a first side view of the breaching tool 100 of FIG. 1. In the illustrated embodiment, the bill 108 includes a top bill side 200 and a bottom bill side 202. The top bill side 200 has a first curvature. The bottom bill side 202 is concave and has a second curvature. For example, in the illustrated embodiment, the top bill side 200 has a first radius of curvature R1 different than a second radius of curvature R2 of the bottom side 202. The first radius of curvature R1 has a first axis of curvature C1. The second radius of curvature R2 has a second axis of curvature C2. In the illustrated embodiment, the first axis of curvature C1 and the second axis of curvature C2 are disposed between the ram 102 and the fork 106.

A first plane A2 intersects the end 124 of the bill 108. The first plane A2 is substantially parallel to the central, longitudinal axis A1 of the bar 104 and substantially perpendicular to the first axis of curvature C1 and the second axis of curvature C2. In the illustrated embodiment, the first axis of curvature C1, the second axis of curvature C2, the head 110, the rod 104, and the fork 106 are disposed on the same side of the first plane A2 (i.e, the left side in the perspective of FIG. 2). Thus, the bill 108 is curved and has a first direction of curvature (i.e., clockwise from the perspective of FIG. 2) relative to the first axis of curvature C1 and/or the second axis of curvature C2 such that the top bill side 200 is convex. In other embodiments, the first axis of curvature C1 and/or the second axis of curvature C2 are disposed in other locations. In some embodiments, the top bill side 200 and/or the bottom bill side 202 may have other configurations (e.g., an increasing radius of curvature or a decreasing radius of curvature, etc.).

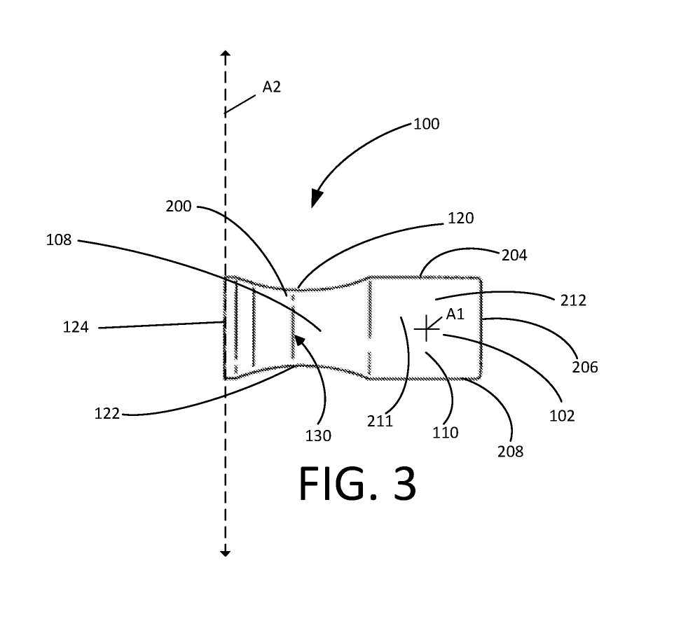

In the illustrated embodiment, the head 110 of the ram 102 is a block. The head 110 has a first head side 204, a second head side 206, a third head side 208 (FIG. 3), a fourth head side 210, and a top head side 211. The first head side 204 is opposite the third head side 208. The second head side 206 is opposite the fourth head side 210. The bottom bill side 202 of the bill 108 extends from the fourth head side 210 of the head 110. The first head side 204, the second head side 206, the third head side 208, and the top head side 211 each define a striking surface. Thus, in the illustrated embodiment, the head 110 of the ram 102 includes four striking surfaces. In some embodiments, the first head side 204, the second head side 206, the third head side 208, and/or the fourth side 210 are planar. In other embodiments, the first head side 204, the second head side 206, the third head side 208, and/or the fourth head side 210 are curved (e.g., convex). The top head side 211 and the top bill side 200 define a top ram side 212 of the ram 102. The top head side 211 has a third curvature. In the illustrated embodiment, the third curvature of the top head side 211 is substantially the same as the first curvature of the top bill side 200. Thus, in the illustrated embodiment, the top head side 211 and the top bill side 200 have the first axis of curvature C1 and the first radius of curvature R1. In the illustrated embodiment, the first curvature of the top bill side 200 and the third curvature of the top head side 211 are substantially continuous to enable the ram 102 to have a range of motion during a prying operation substantially equal to an arc length of the top ram side 212 divided by the first radius of curvature R1 when employed to pry an object (e.g., a door). In other embodiments, the top head side 211 and the top bill side 200 have different centers of curvature and/or different radii of curvature.

The ram 102 is coupled with the bar 104 at a first joint 214. In some embodiments, the first joint 214 is a weld. In some embodiments, a portion of the bar 104 is received in a socket or bore of the head 110. In the illustrated embodiment, the head 110 has a height H of about 3 inches. The height H is measured substantially parallel to the central, longitudinal axis A1 of the rod 104 and from the top head side 211 to a bottom side of the head 215 opposite the top head side 211. The ram 102 of FIG. 2 has a weight of about 20 pounds. However, the above-noted dimensions and weights are merely examples and, thus, other embodiments may include other dimensions and/or weights without departing from the scope of this disclosure. The ram 102 may comprise about half of a total weight of the breaching tool 100. The term “about” means within 5 percent of a value. Thus, weights of 47.5 pounds to 52.5 pounds fall within the scope of about 50 pounds. In the illustrated embodiment, the ram 102 comprises 52% of the total weight of the breaching tool 100.

FIG. 3 is a top view of the example beaching tool 100 of FIGS. 1-2. In some embodiments, the central, longitudinal axis A1 of the bar 104 extends through a center of the head 110 such that a center of gravity of the bar 104 and a center of gravity of the head 110 are disposed on the axis A1 to facilitate breaching a door via the top ram side 212 of the ram 102. In the illustrated embodiment, the bar 104 is straight to minimize twisting of the breaching tool 100 and maximize an amount of force transferred to an object (e.g., door) when striking (e.g., ramming) the object via the head 110. In the illustrated embodiment, the end 124 of the bill 108 is opposite the second head side 206 of the head 110.

In the illustrated embodiment, the bill 108 is integral with the head 110. For example, the bill 108 and the head 110 are a single piece of material such as, for example, steel (e.g., a plain carbon steel, an alloy steel, titanium, and/or one or more additional and/or alternative materials). In some embodiments, the bill 108 and the head 110 are heat treated. In other embodiments, the bill 108 and the head 110 are distinct components, and the bill 108 is coupled to the head 110 in any suitable manner (e.g., via a weld, a press fit, etc.).

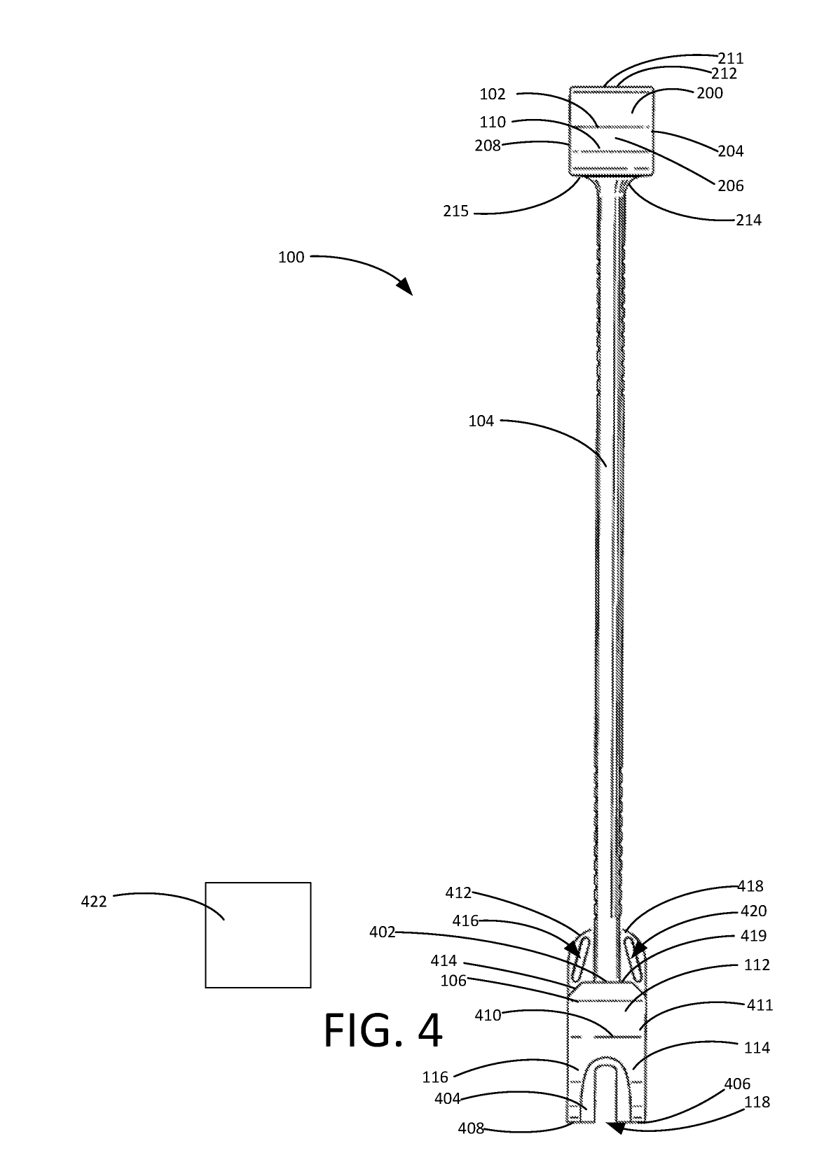

FIG. 4 is a rear view of the example breaching tool 100 of FIGS. 1-3. In the illustrated embodiment, the fork 106 is coupled to the bar 104 at a second joint 402. In some embodiments, the second joint 402 is a weld. The fork 106 includes a track 404 extending from a first tip 406 of the first prong 114 to a second tip 408 of the second prong 116. Thus, the track 404 frames the gap 118. In the illustrated embodiment, the track 404 is a U-shaped recess or cutout that is recessed relative to a first fork side 410 of the body 112, the first prong 114 and the second prong 116. The track 404 is sized and dimensioned to enable the fork 106 to engage a gas shut-off valve.

In the illustrated embodiment, a first tab 412 extends from the bar 104 to a first shoulder 414 of the fork 106. The first tab 412 has a first aperture 416. A second tab 418 extends from the bar 104 to a second shoulder 419 of the fork 106. In the illustrated embodiment, the first tab 412 is oriented substantially parallel to the second tab 418. The rod 104 is disposed between the first shoulder 414 and the second shoulder 419. Thus, the first tab 412 and the second tab 418 are on opposing sides of the bar 104. The second tab 418 has a second aperture 420. In the illustrated embodiment, the first tab 412 is a mirror image of the second tab 418. In other embodiments, the first tab 412 and the second tab 418 have different configurations. For example, the first tab 412, the second tab 418, the first aperture 416, and/or the second aperture 420 may have different shapes, sizes, orientations and/or one or more additional and/or alternative configurations. For example, in some embodiments, the first tab 412 is disposed at an angle (e.g., 15 degrees, 30 degrees, 60 degrees, 90 degrees, and/or any other angle) relative to the second tab 418.

The first aperture 416 and/or the second aperture 420 enable a strap (not shown) to be coupled to the breaching tool 100 adjacent the fork 106 (e.g., within one inch of the fork 106). For example, the strap may be coupled to the first tab 412 and/or the second tab 418 via one or more connectors (e.g., quick release connectors) that extend through the first aperture 416 or the second aperture 420, respectively. The first tab 412 and/or the second tab 418 may extend along a second plane 422 that is substantially parallel with the first plane A2, the end 124 of the bill 108, and/or the second head side 206 of the head 110 such that the first aperture 416 and the second aperture 420 extend through the first tab 412 and the second tab 418, respectively, and in a direction perpendicular to the second plane 422 and the first plane A2. In the illustrated embodiment, the first tab 412 is a fin or a plate.

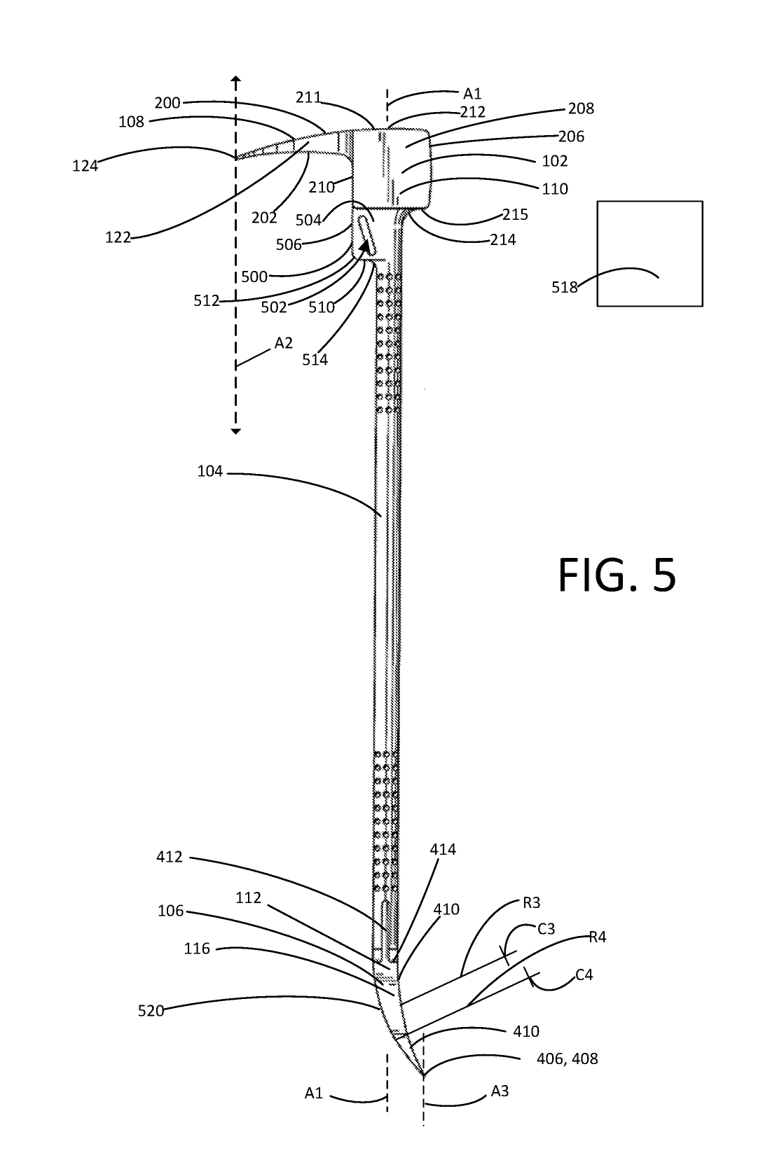

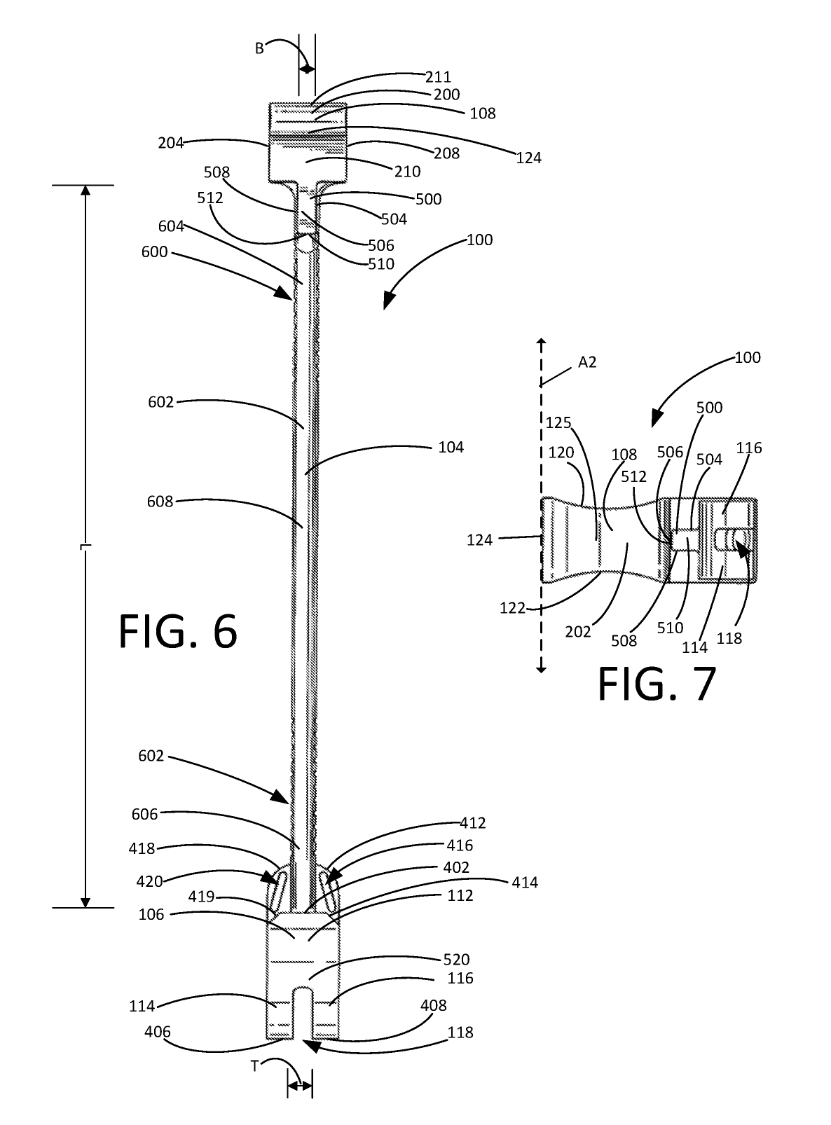

FIG. 5 is a second side view of the example breaching tool 100 of FIGS. 1-4. In the illustrated embodiment, a third tab 500 is coupled to the ram 102 and the bar 104. The third tab 500 includes a third aperture 502. In the illustrated embodiment, the third tab 500 includes a first tab side 504, a second tab side 506, a third tab side 508 (FIG. 6), and a fourth tab side 510. The fourth tab side 510 is substantially perpendicular to the second tab side 506. The third tab 500 includes a first corner 512. The first corner 512 extends from the second tab side 506 to the fourth tab side 510. In the illustrated embodiment, the first corner 512 is a round.

The first tab side 504 is substantially parallel and opposite to the third tab side 508 of the third tab 500. A second corner 514 extends from the fourth tab side 510 to the bar 104. The second corner 514 is a fillet. In the illustrated embodiment, the second corner 514 is rounded for ergonomic purposes. For example, the second corner 514 facilitates gripping of the bar 104 when a hand of a user abuts the third tab 500.

In the illustrated embodiment, the third tab 500 extends from the bar 104 toward the fourth head side 210 of the head 110 and the end 124 of the bill 108 (e.g., away from the second head side 206 of the head 110 along a third plane 518 substantially perpendicular to the second plane 422). The third tab 500 is disposed between the central, longitudinal axis A1 of the bar 104 and the first plane A2. In some embodiments, the third tab 500 has a different orientation than the first tab 412 and/or the second tab 418. For example, in the illustrated embodiment, the third tab 500 is oriented substantially 90 degrees or orthogonal relative to the first tab 412 and/or the second tab 418. In other embodiments, the third tab 500 may be oriented in other ways (e.g., 60 degrees relative to the first tab 412 and/or the second tab 418, 80 degrees relative to the first tab 412 and/or the second tab 418, etc., extending along the second plane 422, etc.).

Still referring to FIG. 5, the body 112 of the fork 106 has a second fork side 520 opposite the first fork side 410. The fork 106 is curved and has a second direction of curvature (i.e., counterclockwise from the perspective of FIG. 5). In the illustrated embodiment, the second direction of curvature of the fork 106 is the same as the first direction of curvature of the bill 108. Thus, the fork 104 curves away from the first plane A2. The first fork side 410 is concave and has a third radius of curvature R3 and a third axis of curvature C3. The second fork side 520 is convex and has a fourth radius of curvature R4 and a fourth axis of curvature C4. The third radius of curvature R3 is different than the fourth radius of curvature R4. In the illustrated embodiment, the third radius of curvature R3 is less than the fourth radius of curvature R4.

In the illustrated embodiment, a fourth plane A3 is substantially parallel to the central, longitudinal axis and the first plane A2. The fourth plane A3 intersects the first tip 406 and the second tip 408 of the first prong 114 and the second prong 116, respectively. The first plane A2 is disposed on a first side of the rod 104, and the fourth plane A3 is disposed on a second side of the rod 104 opposite the first side. Thus, the bill 108 extends away from the fourth plane A3.

FIG. 6 is a rear view of the breaching tool 100 of FIGS. 1-5. In the illustrated embodiment, the third tab 500 has a thickness B of about 1 inch. The thickness B is measured from the first tab side 504 to the third tab side 508, taken substantially perpendicular to the central, longitudinal axis A1 (FIG. 2). In the illustrated embodiment, the thickness B of the third tab 500 is substantially equal to a diameter of the bar 104. In some embodiments, the thickness B of the third tab 500 is equal to about one half of the diameter of the bar 104 to about 1.5 times the diameter of the bar 104. However, the above-noted dimensions are merely examples and, thus, other dimensions may be used without departing from the scope of this disclosure. In the illustrated embodiment, the thickness B enables a user to strike an object (e.g., a door) via the top ram side 212 of the ram 102 while gripping the bar 104 with a hand abutting the third tab 500.

Still referring to FIG. 6, the bar 104 includes a first array of dimples 600 and a second array of dimples 602. The first array of dimples 600 are disposed on a ram end 604 of the bar 104 and the second array of dimples 602 are disposed along a fork end 606 of the bar 104. The ram end 604 is the portion of the bar 104, which comprises about one-third of a length L of the bar 104, closest to the ram 102. The fork end 606 is the portion of the bar 104 closest to the fork 106, which comprises about one-third of the length L of the bar 104. In the illustrated embodiment, a medial portion 608 of the bar 104 does not include dimples. Thus, the first array of dimples 600 is spaced apart from the second array of dimples 602. In some embodiments, the bar 104 includes one or more additional and/or alternative texturing (e.g., the first array of dimples 600 and/or the second array of dimples 602 may be scores, knurls, bumps, protrusions, etc.). In some embodiments, the bar 104 has a smooth surface. The first array of dimples 600 and the second array of dimples 602 facilitate gripping of the bar 104.

In some embodiments, the length L is about 36 inches. In some embodiments, a combined weight of the bar 104 and the fork 106 is about 19 pounds. In some embodiments, the length L of the bar 104 is dimensioned to enable the breaching tool 100 to span a width of a window and/or a doorway. The bar 104 may have a thickness T of about 1 inch. The bar 104 may have a weight of about 6.7 pounds. The fork 106 may have a weight of about 12.3 pounds. The above-noted dimensions and weights are merely examples and, thus, other embodiments may include other dimensions or weights without departing from the scope of this disclosure.

The breaching tool 100 may pry open doors that open inwardly and/or outwardly. In some embodiments, a user of the tool 100 may combine the breaching tool 100 with another tool such as, for example, a breaching tool substantially similar or identical to the breaching tool by engaging the fork 106 with a fork of the other tool. The top ram side 212 of the ram 102 is dimensioned to have a surface area that enables the ram to sever a door from a doorframe when the ram contacts the door. For example, when the ram 102 is driven into the door, the top ram side 212 distributes a force of the breaching tool 100 such that the ram 102 may not puncture the door. Instead, the force is transferred from the door to one or more hinges of the door, severing the one or more hinges and, thus, the door, from a doorframe.

In some examples, the bill 108 or the fork 106 are dimensioned to be received into a door jamb to pry the door from the doorframe. In some embodiments, the fork 106 and/or the bill 108 are dimensioned to fit behind a barrel of a hinge of a door to facilitate prying of the door and/or breaking of the hinge. In some embodiments, the fork 106 is dimensioned to be received into a key of gas shutoff valve, engage objects such as a padlock, chain link, and/or other objects. The fork 106 may pry hinges, nails, screws, components coupled together, and/or one or more additional and/or alternative objects. The fork 106 and the ram 102 are located on opposing ends of the bar 104. The fork 106 and the bill 108 are also curved in the same direction to facilitate prying of objects via the fork 106 and the bill 108. For example, when viewed in the orientation of FIG. 5 the bill 108 and the fork 106 are curved in a counter-clockwise direction.

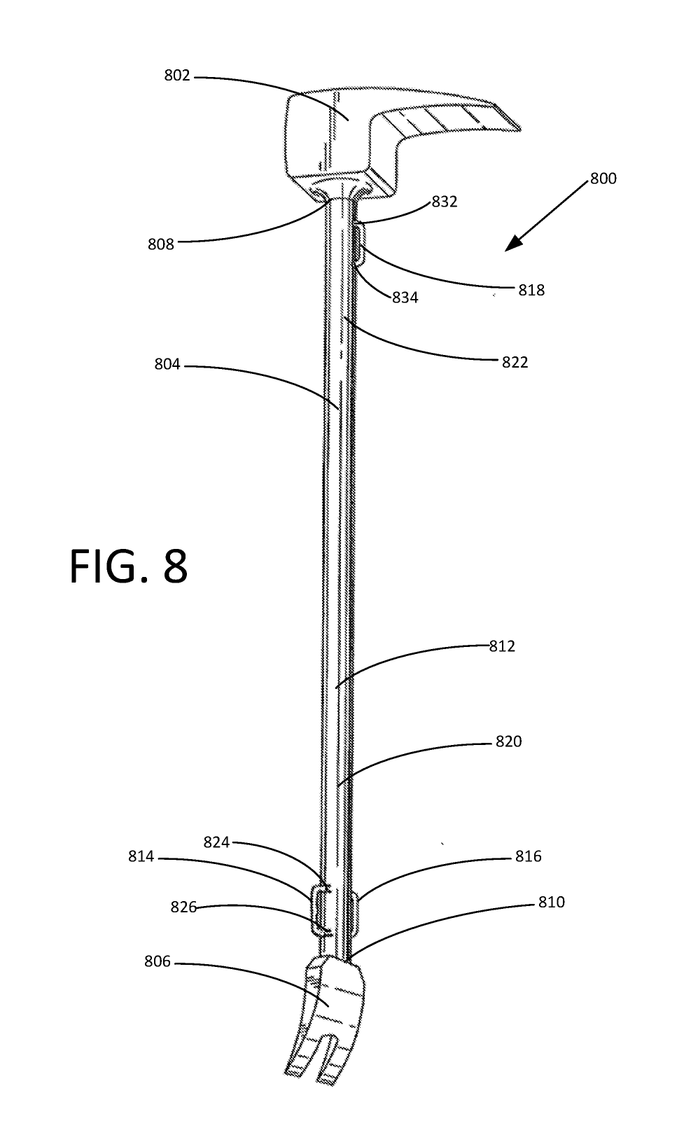

FIGS. 8-10 illustrate another example breaching tool 800 disclosed herein. Referring to FIG. 8, the breaching tool 800 includes a ram 802, a rod 804, and a fork 806. The ram 802 is coupled with the rod 804 at a first joint 808. The fork 806 is coupled with the rod 804 at a second joint 810. In the embodiment of FIG. 8, the rod 804 includes a substantially smooth surface 812. Further, as illustrated in FIG. 8, a first tab 814, a second tab 816, and a third tab 818 are disposed on the rod 804 to enable a strap (not shown) to be coupled to the breaching tool 800 via the first tab 814, the second tab 816, and/or the third tab 818. The first tab 814 and the second tab 816 are spaced apart from the fork 806. The third tab 818 is spaced apart from the ram 802. Thus, the first tab 814 and the second tab 816 are spaced apart from the second joint 810, and the third tab 818 is spaced apart from the first joint 808.

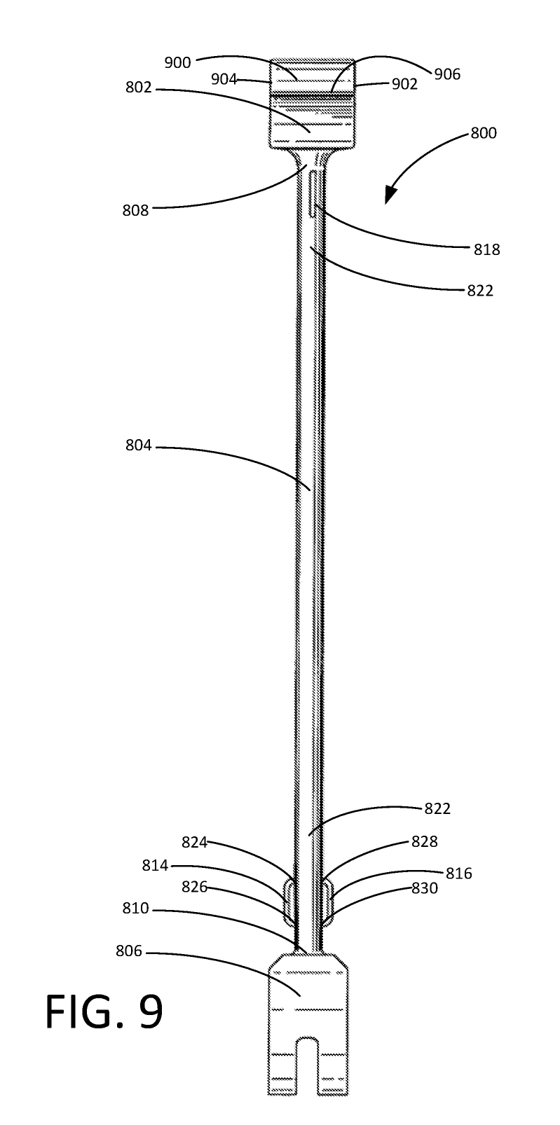

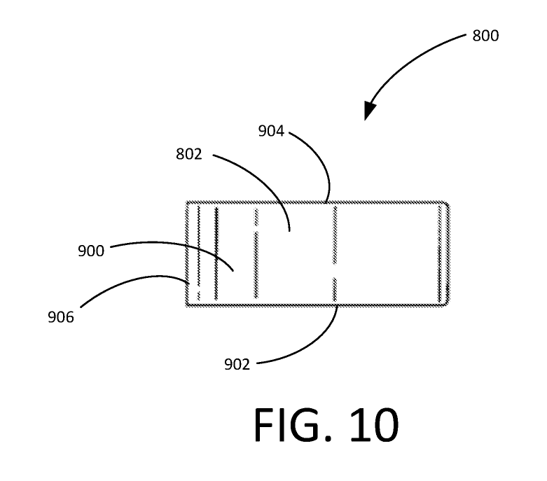

The first tab 814 and the second tab 816 are positioned on a first or fork end 820 of the rod 804 adjacent or near the fork 806. The third tab 812 is positioned on a second or ram end 822 of the rod 804 adjacent or near the fork 806. The first tab 814 is a bar or rung coupled to the rod 804 at a first end 824 of the first tab 814 and a second end 826 of the first tab 814. Referring to FIGS. 8 and 9, the second tab 816 is an elongate bar or rung and is coupled to the rod 804 at a first end 828 (FIG. 9) of the second tab 816 and a second end 830 (FIG. 9) of the second tab 816. The third tab 818 is also an elongated bar or rung and is coupled to the rod 804 at a first end 832 of the third tab 818 and a second end 834 of the third tab 818. In the illustrated embodiment, the first tab 814 and the second tab 816 are disposed on opposite sides of the rod 804. In the illustrated embodiment, the second tab 814 and the third tab 816 are mirror images of each other.

Now referring to FIG. 10, the ram 802 includes a bill 900. The bill 900 includes a first side 902, a second side 904, and a third side 906. The first side 902 and the second side 904 of FIG. 9 are substantially straight. In the illustrated embodiment, the first side 902 is substantially parallel to the second side 904. In the illustrated embodiment, the first side 902 and the second side 904 are orthogonal to the third side 906. In other embodiments, the first side 902 and/or the second side 904 are curved (e.g., convex, concave, etc.).

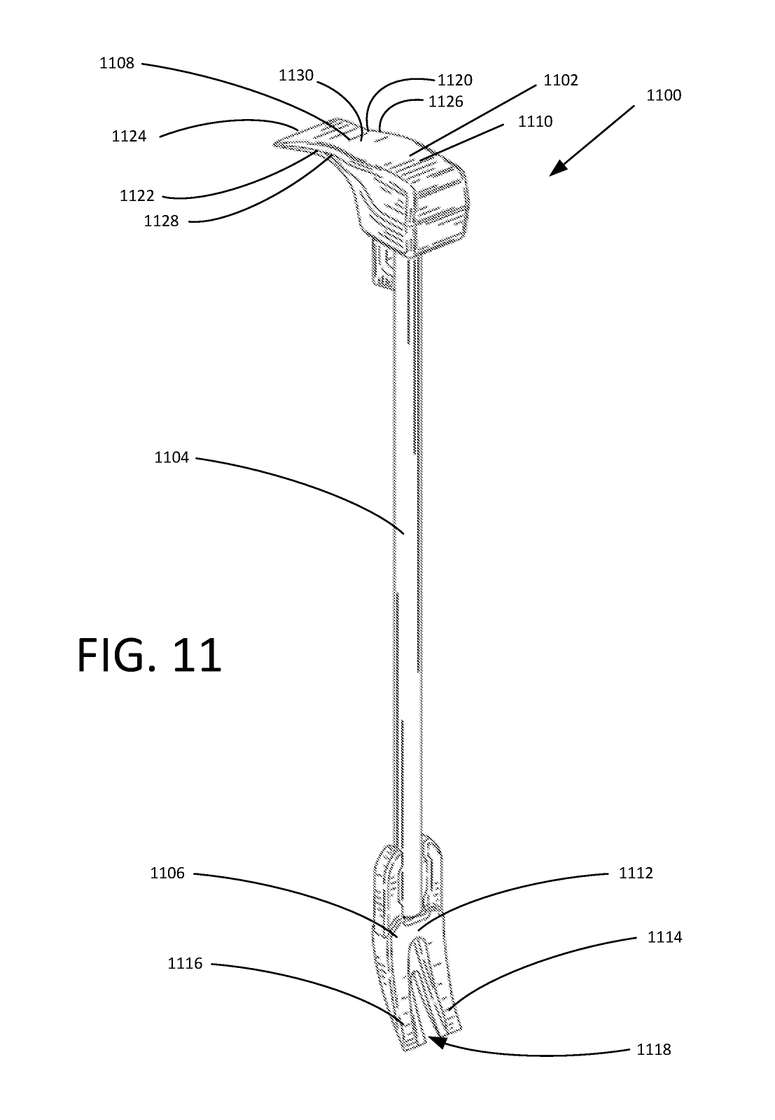

FIG. 11 is a perspective view of another example breaching tool 1100 in accordance with the teachings of this disclosure. The breaching tool 1100 may be used to, for example, breach doors by prying, ramming, striking, and/or one or more additional and/or alternative operations. The breaching tool 1100 of FIG. 11 includes a ram 1102, a bar 1104, and a fork 1106. The ram 1102 includes a bill 1108 and a head 1110. The fork 1106 includes a body 1112 and a first prong 1114 and a second prong 1116. In the illustrated embodiment, the first prong 1114 and the second prong 1116 extend from the body 1112. The first prong 1114 and the second prong 1116 are spaced apart and, thus, a gap 1118 is disposed between the first prong 1114 and the second prong 1116. In the illustrated embodiment, the breaching tool 1100 has a weight of about 40 pounds. In some embodiments, the breaching tool 1100 has other weights. For example, the breaching tool 1100 may have a weight of between about 15 pounds and about 55 pounds.

The example bill 1108 of FIG. 11 extends from the head 1110. The bill 1108 includes a first bill side 1120, a second bill side 1122 opposite the first bill side 1120, and an end 1124 extending from the first bill side 1120 to the second bill side 1122. The end 1124 of FIG. 11 is substantially straight. In other embodiments, the end 1124 may be curved. A first portion 1126 of the first bill side 1120 is concave. A second portion 1128 of the second bill side 1122 is concave. In the illustrated embodiment, the first portion 1126 is opposite the second portion 1128. Thus, the bill 1108 of FIG. 11 includes a minimum width or waist 1130 between the end 1124 and the head 1110 defined by a minimum distance from the first concave portion 1126 of the first bill side 1120 to the second concave portion 1128 of the second bill side 1122. In some embodiments, the waist 1130 facilitates gripping the breaching tool 1100 via the bill 1108. In other embodiments, the bill 1108 has other shapes and/or configurations. For example, the first bill side 1120, the second bill side 1122, and/or the end 1124 may be straight, convex, and/or one or more additional and/or alternative shapes and/or configurations.

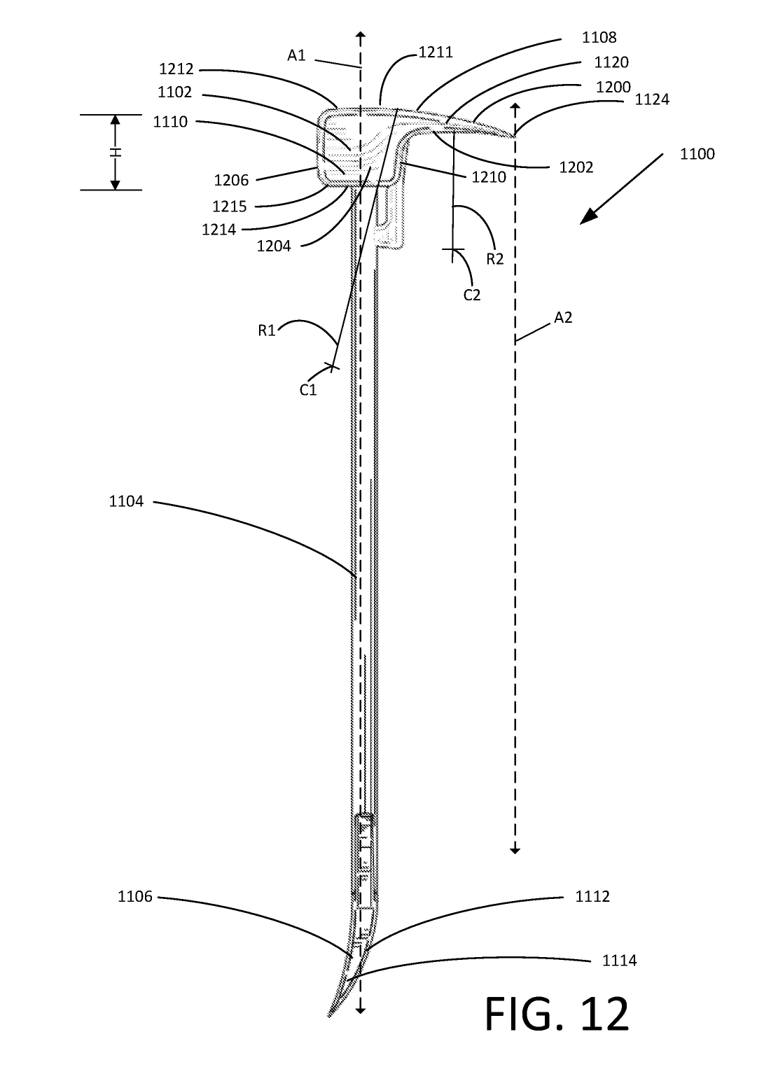

FIG. 12 is a first side view of the breaching tool 1100 of FIG. 11. In the illustrated embodiment, the bill 1108 includes a top bill side 1200 and a bottom bill side 1202. The top bill side 1200 has a first curvature. The bottom bill side 1202 is concave and has a second curvature. For example, in the illustrated embodiment, the top bill side 1200 has a first radius of curvature R1 different than a second radius of curvature R2 of the bottom side 1202. The first radius of curvature R1 has a first axis of curvature C1. The second radius of curvature R2 has a second axis of curvature C2. In the illustrated embodiment, the first axis of curvature C1 and the second axis of curvature C2 are disposed between the ram 1102 and the fork 1106.

A first plane A2 intersects the end 1124 of the bill 1108. The first plane A2 is substantially parallel to the central, longitudinal axis A1 of the bar 1104. The first plane A2 is substantially perpendicular to the first axis of curvature C1 and the second axis of curvature C2. In the illustrated embodiment, the first axis of curvature C1, the second axis of curvature C2, the head 1110, the rod 1104, and the fork 1106 are disposed on the same side of the first plane A2 (i.e, the left side in the perspective of FIG. 12). Thus, the bill 1108 is curved and has a first direction of curvature (i.e., clockwise from the perspective of FIG. 12) relative to the first axis of curvature C1 and/or the second axis of curvature C2 such that the top bill side 1200 is convex. In other embodiments, the first axis of curvature C1 and/or the second axis of curvature C2 are disposed in other locations. In some embodiments, the top bill side 1200 and/or the bottom bill side 1202 may have other configurations (e.g., an increasing radius of curvature or a decreasing radius of curvature, etc.).

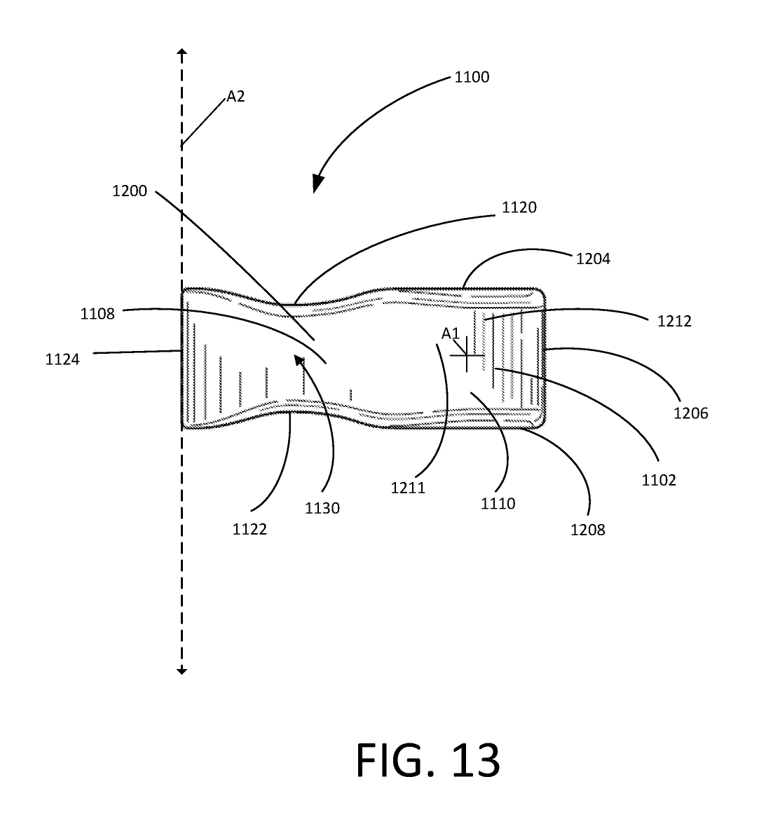

In the illustrated embodiment, the head 1110 of the ram 1102 is a block. The head 1110 has a first head side 1204, a second head side 1206, a third head side 1208 (FIG. 13), a fourth head side 1210, and a top head side 1211. The first head side 1204 is opposite the third head side 1208. The second head side 1206 is opposite the fourth head side 1210. The bottom bill side 1202 of the bill 1108 extends from the fourth head side 1210 of the head 1110. The first head side 1204, the second head side 1206, the third head side 1208, and the top head side 1211 each define a striking surface. Thus, in the illustrated embodiment, the head 1110 of the ram 1102 includes four striking surfaces. In some embodiments, the first head side 1204, the second head side 1206, the third head side 1208, and/or the fourth head side 1210 are planar. In other embodiments, the first head side 1204, the second head side 1206, the third head side 1208, and/or the fourth head side 1210 are curved (e.g., convex). The top head side 1211 and the top bill side 1200 define a top ram side 1212 of the ram 1102. The top head side 1211 has a third curvature. In the illustrated embodiment, the third curvature of the top head side 1211 is substantially the same as the first curvature of the top bill side 1200. Thus, in the illustrated embodiment, the top head side 1211 and the top bill side 1200 have the first axis of curvature C1 and the first radius of curvature R1. In the illustrated embodiment, the first curvature of the top bill side 1200 and the third curvature of the top head side 1211 are substantially continuous to enable the ram 1102 to have a range of motion during a prying operation substantially equal to an arc length of the top ram side 1212 divided by the first radius of curvature R1 when employed to pry an object (e.g., a door). In other embodiments, the top head side 1211 and the top bill side 1200 have different centers of curvature and/or different radii of curvature.

The ram 1102 is coupled with the bar 1104 at a first joint 1214. In some embodiments, the first joint 1214 is a weld. In some embodiments, a portion of the bar 1104 is received in a socket or bore of the head 1110. In the illustrated embodiment, the head 1110 has a height H of about 3 inches. The height H is measured substantially parallel to the central, longitudinal axis A1 of the rod 1104 and from the top head side 1211 to a bottom side of the head 1215 opposite the top head side 1211. The ram 1102 of FIG. 12 has a weight of about 20 pounds. However, the above-noted dimensions and weights are merely examples and, thus, other embodiments may include other dimensions and/or weights without departing from the scope of this disclosure. In some embodiments, the ram 1102 may comprise about half of a total weight of the breaching tool 1100. In the illustrated embodiment, the ram 1102 comprises 52% of the total weight of the breaching tool 1100.

FIG. 13 is a top view of the example beaching tool 1100 of FIGS. 11-12. In some embodiments, the central, longitudinal axis A1 of the bar 1104 extends through a center of the head 1110 such that a center of gravity of the bar 1104 and a center of gravity of the head 1110 are disposed on the axis A1 to facilitate breaching a door via the top ram side 1212 of the ram 1102. In the illustrated embodiment, the bar 1104 is straight to minimize twisting of the breaching tool 1100 and maximize an amount of force transferred to an object (e.g., door) when striking (e.g., ramming) the object via the head 1110. In the illustrated embodiment, the end 1124 of the bill 1108 is opposite the second head side 1206 of the head 1110.

In the illustrated embodiment, the bill 1108 is integral with the head 1110. For example, the bill 1108 and the head 1110 are a single piece of material such as, for example, steel (e.g., a plain carbon steel, an alloy steel, titanium, and/or one or more additional and/or alternative materials). In some embodiments, the bill 1108 and the head 1110 are heat treated. In other embodiments, the bill 1108 and the head 1110 are distinct components, and the bill 1108 is coupled to the head 1110 in any suitable manner (e.g., via a weld, a press fit, etc.).

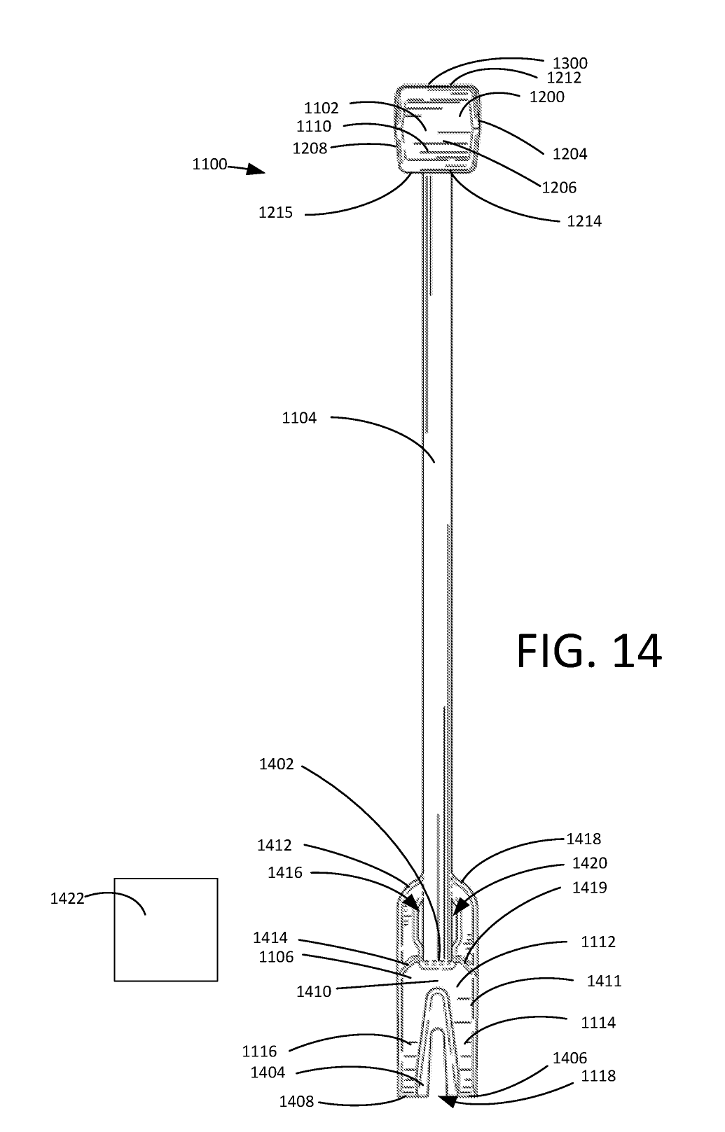

FIG. 14 is a rear view of the example breaching tool 1100 of FIGS. 11-13. In the illustrated embodiment, the fork 1106 is coupled to the bar 1104 at a second joint 1402. In some embodiments, the second joint 1402 is a weld. The fork 1106 includes a track 1404 extending from a first tip 1406 of the first prong 1114 to a second tip 1408 of the second prong 1116. Thus, the track 1404 frames the gap 1118. In the illustrated embodiment, the track 404 is a V-shaped recess or cutout that is recessed relative to a first fork side 1410 of the body 1112, the first prong 1114 and the second prong 1116. The track 1404 is sized and dimensioned to enable the fork 1106 to engage a gas shut-off valve.

In the illustrated embodiment, a first tab 1412 is coupled to and extends from the bar 1104 and a first shoulder 1414 of the fork 1106. The first tab 1412 and the bar 1104 define a first aperture 1416. In the illustrated embodiment, the first tab 1412 is a finger. A second tab 1418 is coupled to and extends from the bar 1104 and a second shoulder 1419 of the fork 1106. The second tab 1418 of FIG. 14 is a finger. In the illustrated embodiment, the first tab 1412 is oriented substantially parallel to the second tab 1418. The rod 1104 is disposed between the first shoulder 1414 and the second shoulder 1419. Thus, the first tab 1412 and the second tab 1418 are disposed on opposing sides of the bar 1104. The second tab 1418 and the bar 1104 define a second aperture 1420. In the illustrated embodiment, the first tab 1412 is a mirror image of the second tab 1418. The first tab 1412 and/or the second tab 1418 may extend along a second plane 1422 that is substantially parallel with the first plane A2, the end 1124 of the bill 1108, and/or the second head side 1206 of the head 1110 such that the first aperture 1416 and the second aperture 420 extend in a direction perpendicular to the second plane 422 and the first plane A2. In other embodiments, the first tab 1412 and the second tab 1418 have different configurations. For example, the first tab 1412, the second tab 1418, the first aperture 1416, and/or the second aperture 1420 may have different shapes, sizes, orientations and/or one or more additional and/or alternative configurations. For example, in some embodiments, the first tab 1412 is disposed at an angle (e.g., 15 degrees, 30 degrees, 60 degrees, 90 degrees, and/or any other angle) relative to the second tab 1418.

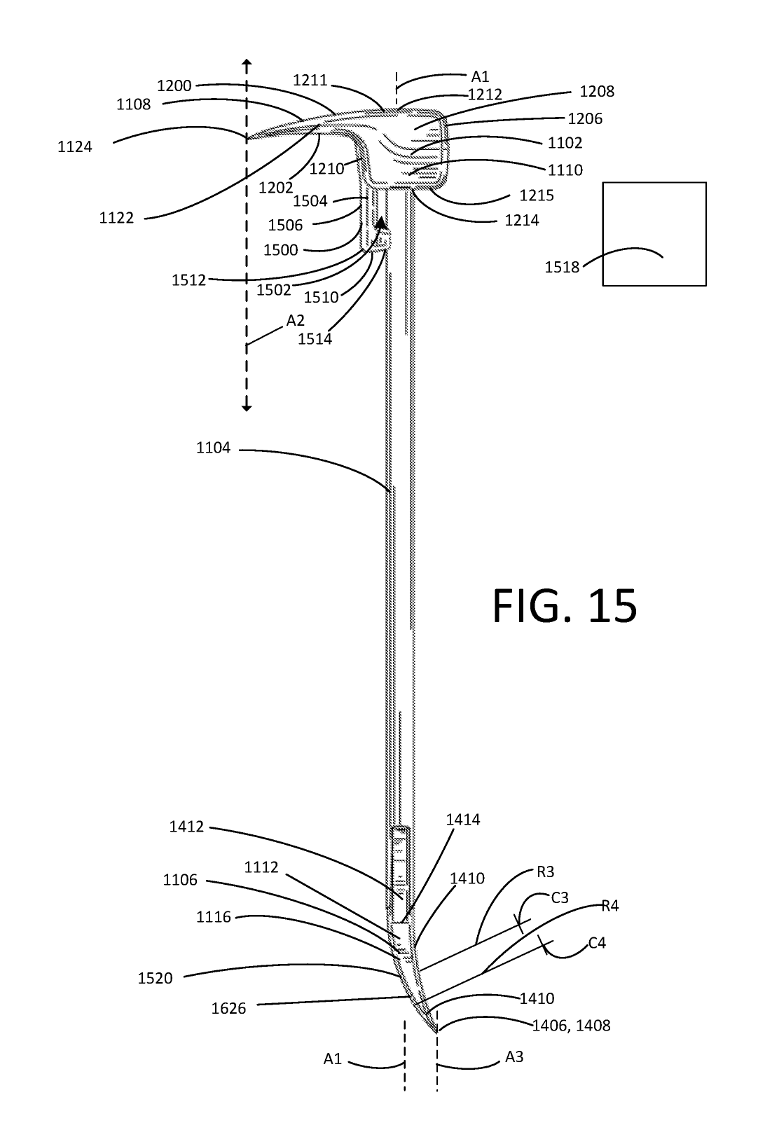

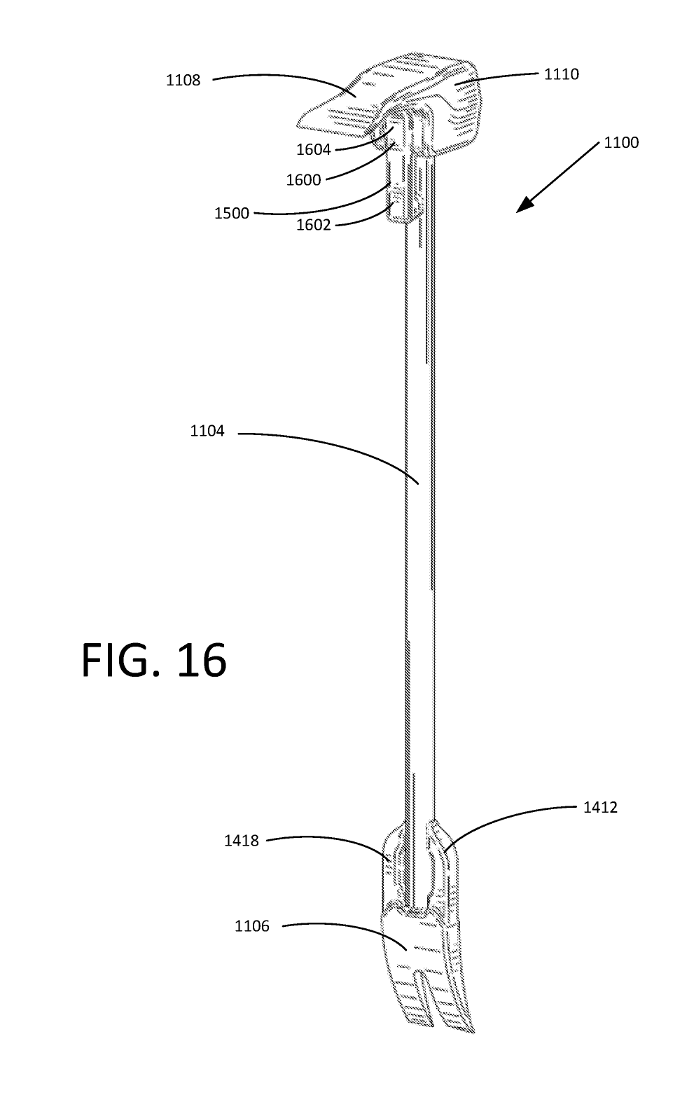

FIG. 15 is a second side view of the example breaching tool 1100 of FIGS. 11-14. In the illustrated embodiment, a third tab 1500 is coupled to the ram 1102 and the bar 1104. The third tab 1500, the bar 1104, and the bottom side of the head 1215 define a third aperture 1502. In the illustrated embodiment, the third aperture 1502 extends substantially parallel to the first plane A2 and the first axis of curvature C1. In the illustrated embodiment, the third tab 1500 is L-shaped. In other embodiments, the third tab 1500 has other shapes (e.g., curved). In the illustrated embodiment, the third tab 1500 includes a first tab side 1504, a second tab side 1506, a third tab side 1508 (FIG. 16), and a fourth tab side 1510. The fourth tab side 1510 is substantially perpendicular to the second tab side 1506. The third tab 1500 includes a first corner 1512. The first corner 1512 extends from the second tab side 1506 to the fourth tab side 1510. In the illustrated embodiment, the first corner 1512 is a round.

The first tab side 1504 is substantially parallel and opposite to the third tab side 1508 of the third tab 1500. A second corner 1514 extends from the fourth tab side 1510 to the bar 1104. The second corner 1514 is a fillet. In some embodiments, the second corner 1514 is rounded for ergonomic purposes. For example, the second corner 514 facilitates gripping of the bar 1104 when a hand of a user abuts the third tab 1500.

In the illustrated embodiment, the third tab 1500 extends from the bar 1104 toward the fourth head side 1210 of the head 1110 and the end 1124 of the bill 1108 (e.g., away from the second head side 1206 of the head 1110 along a third plane 1518 substantially perpendicular to the second plane 1422). The third tab 1500 is disposed between the central, longitudinal axis A1 of the bar 1104 and the first plane A2. In some embodiments, the third tab 1500 has a different orientation than the first tab 1412 and/or the second tab 1418. For example, in the illustrated embodiment, the third tab 1500 is oriented substantially 90 degrees or orthogonal relative to the first tab 1412 and/or the second tab 1418. In other embodiments, the third tab 1500 may be oriented in other ways (e.g., 60 degrees relative to the first tab 1412 and/or the second tab 1418, 80 degrees relative to the first tab 1412 and/or the second tab 1418, etc., extending along the second plane 422, etc.).

Still referring to FIG. 15, the body 1112 of the fork 1106 has a second fork side 1520 opposite the first fork side 1410. The fork 1106 is curved and has a second direction of curvature (i.e., counterclockwise from the perspective of FIG. 15). In the illustrated embodiment, the second direction of curvature of the fork 1106 is the same as the first direction of curvature of the bill 1108. Thus, the fork 1104 curves away from the first plane A2. The first fork side 1410 is concave and has a third radius of curvature R3 and a third axis of curvature C3. The second fork side 1520 is convex and has a fourth radius of curvature R4 and a fourth axis of curvature C4. The third radius of curvature R3 is different than the fourth radius of curvature R4. In the illustrated embodiment, the third radius of curvature R3 is less than the fourth radius of curvature R4.

In the illustrated embodiment, a fourth plane A3 is substantially parallel to the central, longitudinal axis and the first plane A2. The fourth plane A3 intersects the first tip 1406 and the second tip 1408 of the first prong 1114 and the second prong 1116, respectively. The first plane A2 is disposed on a first side of the rod 1104, and the fourth plane A3 is disposed on a second side of the rod 1104 opposite the first side. Thus, the bill 1108 extends away from the fourth plane A3.

FIG. 16 is another isometric view of the breaching tool of FIGS. 11-15. In the illustrated embodiment, the fourth head side 1210 includes a ridge or spine 1600. The spine 1600 protrudes toward the first plane A2. In the illustrated embodiment, a portion 1602 of the third tab 1500 mates with the spine 1600. In some embodiments, the second tab side 1506 is substantially flush with a surface 1604 the spine 1600 facing the first plane A2.

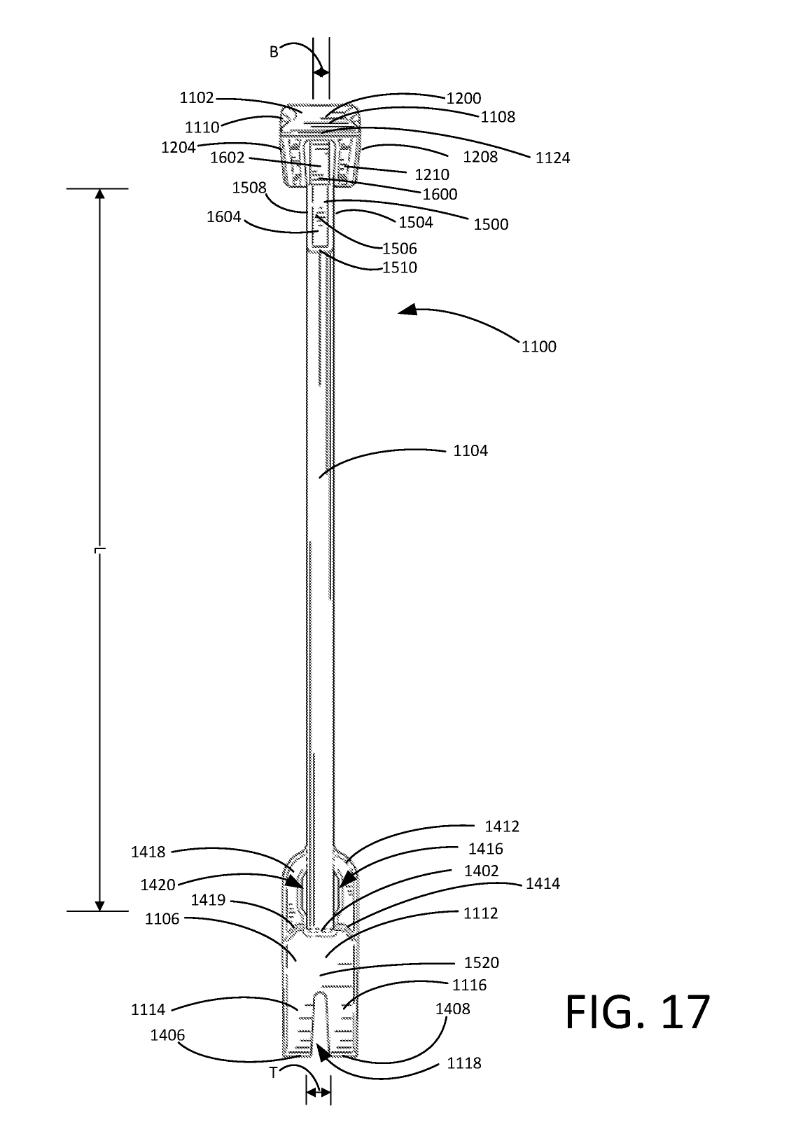

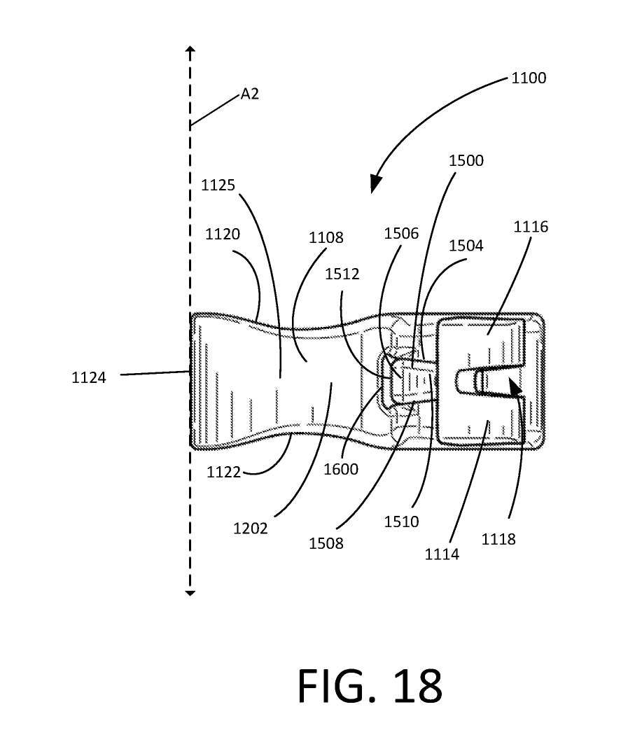

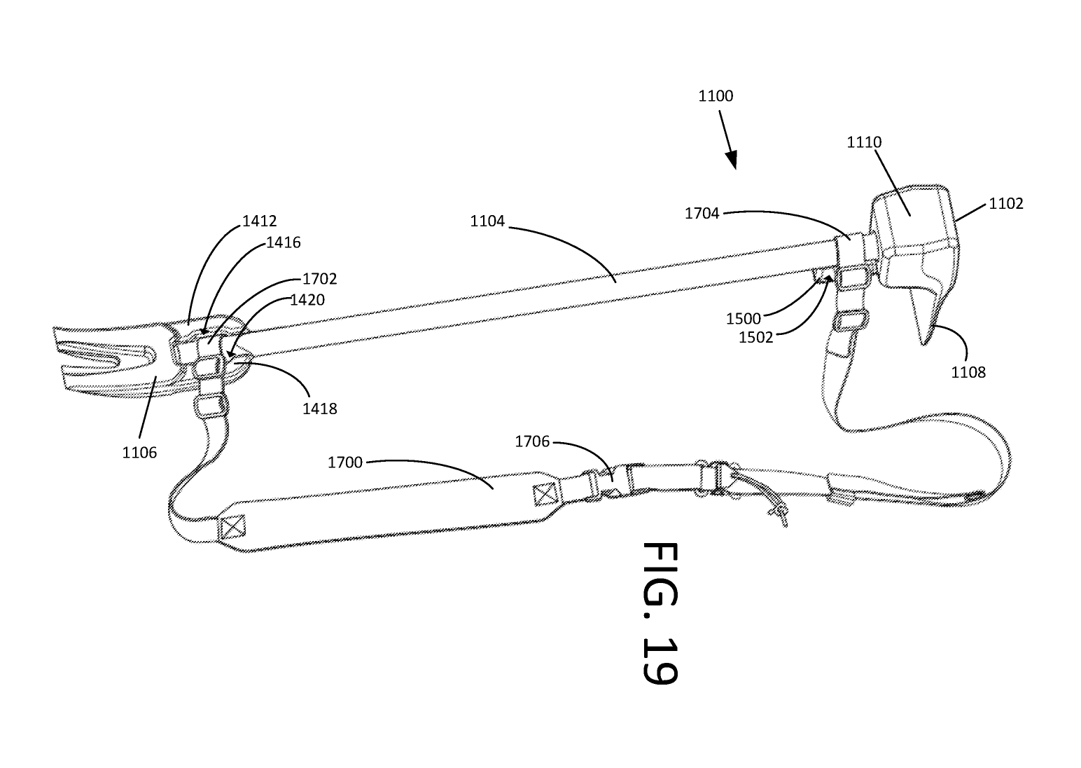

FIG. 17 is a rear view of the breaching tool 1100 of FIGS. 11-16. In the illustrated embodiment, the third tab 1500 has a thickness B of about 1 inch. The thickness B is measured from the first tab side 1504 to the third tab side 1508, taken substantially perpendicular to the central, longitudinal axis A1 (FIG. 12). In the illustrated embodiment, the thickness B of the third tab 1500 is substantially equal to a diameter of the bar 1104. In some embodiments, the thickness B of the third tab 1500 is equal to about one half of the diameter of the bar 1104 to about 1.5 times the diameter of the bar 1104. However, the above-noted dimensions are merely examples and, thus, other dimensions may be used without departing from the scope of this disclosure. In the illustrated embodiment, the thickness B enables a user to strike an object (e.g., a door) via the top ram side 1212 of the ram 1102 while gripping the bar 1104 with a hand abutting the third tab 1500.

In some embodiments, the length L is about 36 inches. In some embodiments, a combined weight of the bar 1104 and the fork 1106 is about 19 pounds. In some embodiments, the length L of the bar 1104 is dimensioned to enable the breaching tool 1100 to span a width of a window and/or a doorway. The bar 1104 may have a thickness T of about 1 inch. The bar 1104 may have a weight of about 6.7 pounds. The fork 1106 may have a weight of about 12.3 pounds. The above-noted dimensions and weights are merely examples and, thus, other embodiments may include other dimensions or weights without departing from the scope of this disclosure.

The breaching tool 1100 may pry open doors that open inwardly and/or outwardly. In some embodiments, a user of the tool 1100 may combine the breaching tool 1100 with another tool such as, for example, a breaching tool substantially similar or identical to the breaching tool 1100 by engaging the fork 1106 with a fork of the other tool. The top ram side 1212 of the ram 1102 is dimensioned to have a surface area that enables the ram to sever a door from a doorframe when the ram contacts the door. For example, when the ram 1102 is driven into the door, the top ram side 1212 distributes a force of the breaching tool 1100 such that the ram 1102 may not puncture the door. Instead, the force is transferred from the door to one or more hinges of the door, severing the one or more hinges and, thus, the door, from a doorframe.

In some examples, the bill 1108 or the fork 1106 are dimensioned to be received into a door jamb to pry the door from the doorframe. In some embodiments, the fork 1106 and/or the bill 1108 are dimensioned to fit behind a barrel of a hinge of a door to facilitate prying of the door and/or breaking of the hinge. In some embodiments, the fork 1106 is dimensioned to be received into a key of gas shutoff valve, engage objects such as a padlock, chain link, and/or other objects. The fork 1106 may pry hinges, nails, screws, components coupled together, and/or one or more additional and/or alternative objects. The fork 1106 and the ram 1102 are located on opposing ends of the bar 1104. The fork 1106 and the bill 1108 are also curved in the same direction to facilitate prying of objects via the fork 1106 and the bill 1108. For example, when viewed in the orientation of FIG. 15 the bill 1108 and the fork 1106 are curved in a counter-clockwise direction.

FIG. 19 illustrates the breaching tool 1100 including a strap 1700. The first tab 1412, the second tab 1418, and the third tab 1500 enable the strap 1700 to be coupled to the breaching tool 1100. In the illustrated embodiment, the strap 1700 is coupled directly to the bar 1104. For example, the strap 1700 of FIG. 19 includes a first portion 1702 extending through the first aperture 1416 and the second aperture 1420 and is looped around the bar 1104 to enable the strap 1700 to be coupled to the breaching tool 1100 adjacent the fork 1106. The first tab 1412 and the second tab 1418 obstruct the first portion 1702 of the strap 1700 from sliding along the rod 1104 toward the ram 1102.

The strap 1700 of FIG. 19 also includes a second portion 1704 extending through the third aperture 1502 and looped around the bar 1104 to enable the strap 1700 to be coupled to the breaching tool 110 adjacent the ram 1102. The third tab 1500 obstructs the second portion 1704 of the strap 1700 from sliding along the rod 1104 toward the fork 1106. In other embodiments, the strap 1700 may be coupled to the first tab 1412, the second tab 1418, the third tab 1500, and/or the bar 1104 via one or more connectors (e.g., hooks, quick release connectors, carabiners, etc.). In the illustrated embodiment, the strap 1700 includes a buckle 1706 to enable a user to separate the first portion 1702 of the strap 1700 from the second portion 1704 of the strap 1700 or couple the first portion 1702 to the second portion 1704.

Although example breaching tools are disclosed herein, the scope of coverage of this patent is not limited thereto. On the contrary, this patent covers all methods, apparatus and articles of manufacture fairly falling within the scope of this patent either literally or under the doctrine of equivalents.

We claim:

1. A breaching tool, comprising:
a head including a first top surface, the first top surface having a first radius of curvature and a first axis of curvature;
a bill extending from the head, the bill including a second top surface and an end, the second top surface having a second radius of curvature and a second axis of curvature, wherein the first radius of curvature is substantially equal to the second radius of curvature, and the first axis of curvature is substantially the same as the second axis of curvature;
a rod coupled to the head, the rod having a longitudinal axis;
a fork coupled to the rod, the fork having a first prong and a second prong, the first prong including a first tip, the second prong including a second tip, wherein a first plane substantially parallel to the longitudinal axis and intersecting the end of the bill is disposed on a first side of the rod, and wherein a second plane substantially parallel to the longitudinal axis and the first plane and intersecting the first tip and the second tip is disposed on a second side of the rod opposite the first side;
a first tab coupled to the head and the rod; and
a second tab coupled to the fork and the rod, the first tab substantially perpendicular to the second tab.

2. The breaching tool of claim 1, wherein the first tab and the bar define a first aperture, and wherein the breaching tool further comprises a strap, the strap having a first portion extending through the first aperture and looping around the bar.

3. The breaching tool of claim 2, wherein the second tab and the bar define a second aperture, the strap having a second portion extending through the second aperture and looping around the bar.

4. The breaching tool of claim 1, wherein the bill includes a waist.

5. The breaching tool of claim 1, wherein the ram has four striking surfaces.

6. The breaching tool of claim 1, wherein the first tab has a thickness equal to about two thirds of a diameter of the bar to about the diameter of the bar.

7. The breaching tool of claim 1, wherein the bill is curved in a first direction of curvature relative to the first axis of curvature, the fork is curved in a second direction of curvature relative to the first axis of curvature, and the first direction of curvature is the same as the second direction of curvature.

8. A breaching tool, comprising:
a rod having a longitudinal axis;
a head coupled to the rod;
a bill disposed on a side of the longitudinal axis and extending from the head, the bill having a first direction of curvature relative to a first axis of curvature;
a fork coupled to the rod, the fork having a second direction of curvature, the second direction of curvature being the same as the first direction of curvature such that a tip of the fork is disposed on a second side of the longitudinal axis opposite the first side;
a first tab coupled to the rod, the first tab having a first orientation and disposed on the side of the longitudinal axis; and
a second tab coupled to the rod, the second tab having a second orientation, the first orientation different than the second orientation.

9. The breaching tool of claim 8, wherein the second orientation is substantially perpendicular to the first orientation.

10. The breaching tool of claim 8, wherein the bill has a first side, a second side opposite the first side, and an end extending from the first side to the second side, wherein a portion of the first side is concave.

11. The breaching tool of claim 8, wherein the fork comprises a first prong and a second prong, the tip being a first tip of the first prong, the second prong including a second tip, the second tip disposed on the second side of the longitudinal axis.

12. The breaching tool of claim 11, wherein the head and the bill define a top side of the ram, the top side having a continuous curvature to enable the ram to have a range of motion during prying to be substantially equal to an arc length of the top side of the ram divided by a first radius of curvature R1 of the top side.

13. The breaching tool of claim 8, wherein a strap is coupled to the breaching tool via the first tab, a first portion of the rod, the second tab, and a second portion of the rod.

14. The breaching tool of claim 8, wherein the head includes a first striking surface opposite a second striking surface.

15. A breaching tool, comprising:
a rod;
a block coupled to the rod, the block including a first side and a second side opposite the first side, the first side defining a striking surface;
a bill extending from the second side of the block;
a first tab coupled to the rod and the second side of the block, the first tab defining a portion of a first aperture having a first orientation;
a fork coupled to the rod;
a second tab coupled to the rod and the fork, the second tab defining a portion of a second aperture having a second orientation, the second orientation substantially orthogonal to the first orientation.

16. The breaching tool of claim 15, wherein the first tab has a thickness equal to about two thirds of a diameter of the bar to about the diameter of the bar.

17. The breaching tool of claim 15, wherein a first curvature of a first top side of the bill and a second curvature of a second top side of the block are substantially continuous.

18. The breaching tool of claim 17, wherein the first top surface of the bill has a first radius of curvature and a first axis of curvature, the second top surface of the block has a second radius of curvature and a second axis of curvature, and wherein the first radius of curvature is substantially equal to the second radius of curvature, and the first axis of curvature is substantially the same as the second axis of curvature.

19. The breaching tool of claim 15, further comprising a strap, a first portion of the strap to extend through the first aperture, a second portion of the strap to extend through the second aperture.

20. The breaching tool of claim 15, wherein the bill is curved in a first direction of curvature relative to an axis of curvature, the fork is curved in a second direction of curvature relative to the axis of curvature, and the first direction of curvature is the same as the second direction of curvature.
